(19) United States
(12) Patent Application Publication
(10) Pub. No.: US 2021/0035544 A1
(43) Pub. Date: Feb. 4, 2021

(54) INTERCHANGEABLE PICKUP SYSTEM

(71) Applicant: Small Stage LLC, Whitinsville, MA (US)

(72) Inventor: Steve Skillings, Whitinsville, MA (US)

(21) Appl. No.: 16/942,979

(22) Filed: Jul. 30, 2020

Related U.S. Application Data
(60) Provisional application No. 62/880,884, filed on Jul. 31, 2019.

(51) Int. Cl. G10H 3/18

(52) U.S. Cl. CPC G10H 3/181; G10D 1/085; G10H 3/183

(57) ABSTRACT

A docking system for an electromagnetic pickup of a musical instrument comprises an electromagnetic pickup mounting plate upon which the electromagnetic pickup is mounted and a body mounting plate. The electromagnetic pickup mounting plate includes a first electrical contact configured to be electrically connected to the electromagnetic pickup. The body mounting plate includes a second electrical contact configured to electrically connect to the first electrical contact of the electromagnetic pickup mounting plate and configured to be electrically coupled to external electronics for receiving electrical signals from the electromagnetic pickup and a mechanical detent configured to mechanically interface with the electromagnetic pickup mounting plate to detachably secure the electromagnetic pickup mounting plate to the body mounting plate.

### CROSS-REFERENCE TO RELATED APPLICATIONS

This application claims priority to U.S. Application Ser. No. 62/880,884, filed on Jul. 31, 2019, incorporated herein by reference.

### BACKGROUND

This invention relates to an electric guitar and bass pickup systems.

Electrified instruments, commonly guitar, bass guitar and some acoustic guitars for concerts, use electromagnetic transducers, including a coil and a magnet, to send vibration signals to an amplification system, such as a guitar amplifier or public access system (PA system).

“Pickup” is the vernacular term for the transducers on stringed instruments like guitars and basses. These transducers are comprised of magnet(s) and bobbin(s) structure that create a transformer capable of converting the vibrations of the metal strings to electric signals that are then modified by the guitars volume and tone control and then turned to sound waves using amplifier and speaker electronics and transducers.

As guitars became more and more popular in the 1950's and beyond, manufacturers have modified and optimized designs of the pickups to create a variety of styles, output levels, efficiencies, and even aesthetic treatments. Manufacturers have created a variety of recognizable styles of pickups to meet customer demands, for example, “single coil,” “humbucker,” “P90,” “mini-humbucker,” “lipstick,” and “goldfoil.” These names represent landmark design styles that multiple manufacturers create pickups for, to meet demand in the market, alongside less well-known categories or coming up with their own novel new approaches. As instrument manufacturers improved their construction methods and new materials became available, manufacturers created different output characteristics of pickups, thus creating a variety of possibilities of electronic response characteristics from the same style of pickup. Likewise, the aesthetic of these styles created a look that a particular musician might like, for example “chrome cover,” “gold cover,” “blackout,” and “zebra,” are popular color styles. There are many color options as well, from antique white to chartreuse green and every imaginable color combination. The variety of electronic designs, aesthetic designs and color combinations make the pickup world nearly unlimited in options for consumers.

The variety of styles of instruments is equally diverse. Different body shapes and types of wood used to create the instrument can greatly affect the vibration of the strings. A soft wood dampens the vibration of the instrument more rapidly. A hard wood allows strings to resonate longer. An instrument's shape also effects the vibration of the strings; each shape has different resonant characteristics. The method the pickups are mounted to the guitar also effects the responsiveness of the system, and its ability to transduce the instrument's vibrations. Mounting the pickup directly to the wood/body, or to a pick guard, or to a small mounting ring, effects the resonance and sensitivity of the system comprised of the strings, wood and pickups, and thus it impacts the sound produced by the instrument when amplified. Because of this characteristic of instruments with pickups, when a musician plays a variety of music, they tend to own multiple instruments for different sounds related to different styles of music. Much like a trumpet and trombone sound different, a Telecaster style electric guitar and a Les Paul style guitar sound different due to the pickup design, the shape of the guitar, the wood used, the mounting method of the pickups and many other details. Summarily, the entire system is interacting with all components in the system to create a unique sound for each instrument.

In some instances, the pickups that come with a guitar when purchased are not ideal for the style of music that the owner wants. Therefore, it is very common for musicians to remove the original pickups and replace them with a different pickup. Sometimes, pickups are changed simply for aesthetic reasons. In either case, or both cases, standard pickup installations are created by permanently connecting to the guitar's controls (volume, tone and output jack) via solder and wiring. This wiring is hidden and protected inside the instrument's body via plastic covers and/or through holes drilled in the wood. As such, changing the pickup(s) is a lengthy project that often requires the skills of an experienced technician with excellent soldering skills and a good understanding of electronics. Accordingly, there have been many ideas on how to improve this system to make it more user friendly, faster, and require minimal to no knowledge of electronics.

Vintage instruments are often coveted for the vibration response of the aged wood. It is generally accepted that the older wood gets, the more pleasant the sound, and the more valuable the instrument. It is not unusual to read about vintage guitars selling today for $20,000 to $200,000+ though they originally sold for $250 in 1950's. The increased value is due to the sound or “tone” of the instrument improved with time/age. Most wooden instruments, like a Stradivarius violin, get better with age, so modifying the original wood is never desirable, thus modifying the instrument's wood, even a slight amount causes, it to devalue significantly. Thus, cutting the wood or modifying a vintage instrument to make pickup swapping easier would render such a system as an unusable solution by nearly all musicians, and would most certainly significantly degrade the resale value of an existing instrument of any vintage.

Microphonic feedback is created by high SPL (Sound Pressure Level) playing environments, like a small rehearsal room, a live performance at a club, a large arena, and sometimes at home when conditions allow for turning up amplifiers to high SPL levels for recording or practice. Microphonic feedback occurs when sound pressure levels are high enough to induce additional vibrations, not from the strings, to the instrument and its components. When pickup components move in reaction to the high SPL levels common with contemporary music, they can begin to resonate and can cause a high-pitched squeal, or low rumble, that is uncontrollable and undesirable. Often microphonic feedback is not harmonic in nature, meaning it is not musically desirable or useful. However, “Instrument feedback,” feedback cause by vibrating wood and strings, is harmonic in nature and can be a musically desirable effect for some styles of music.

A loose mechanical connection design and construction is not desirable for many modern styles of music where high SPL levels, and/or variety of stage and rehearsal environments are likely. Lastly, should the musician push hard enough on the pickup itself, it is possible to bend the plug and jack assembly rendering the pickup stuck in the guitar, making the ability to swap a pickup quickly and without tools impossible.

### SUMMARY

With the above background in mind, it is among the primary objectives of the present invention to provide an improved approach for replaceable pickup system for instruments without the services of a professional musical instrument repairman. It is another objective to allow for the changing of any pickup without the need to take the instrument apart to change the pickups. It is another objective to create a replaceable pickup system that is installed into the instrument with no modification to the body, wood or to any component of the instrument that impacts the resonance of the instrument. It is another objective to create a system that allows for existing, instrument shapes to be used, requiring no body shape design, or redesign, to accommodate the system. It is another objective to create a system that has no microphonic feedback at high Sound Pressure Levels (SPL) as required by modern styles of music and venues. It is another objective to work perfectly over a variety of environmental conditions and changes in conditions. It is also an objective of the system to prevent installation errors of the pickup, such as upside-down installation or installing a “passive” pickup in an “active” electronics system by using a “key” feature in the docking system.

These objectives are accomplished by having a detachable “pickup” for instruments that can mount to existing features in the instrument, requiring no modification to the instrument. A “pickup” is a group of components that can be mounted to an instrument in order to generate an electric signal from the vibrating string(s) for amplification. The invention has two main novel components, namely the bobbin mounting plate and the body mounting plate. The bobbin mounting plate is designed to hold the pickup “bobbin,” which is sometimes called the “magnet and coil” or “transducer.” It is designed to manage both a mechanical connection to the instrument and the electrical contacts with the base plate. The term bobbin describes the assembly of magnets, magnet holders, coil or plurality of coils and any other components that are used in a pickup design to capture the vibrations of the strings and convert them to electric signals. The body base plate connects to the instrument. The body mounting plate may attach to a pick guard, a pickup ring, directly to the wood, or via any number of commonly used systems for attaching existing pickups to instruments. The system uses the body mounting plate to attach to the instrument's pickup mounting features and then connect to the instruments electronics components such as a volume control potentiometer, a tone control, a grounding wire, a preamp system, or other commonly found electronics inside an instrument. The base plate's electronic contacts may connect via one or more methods such as, soldered, a set screw, a press fit clamp, or via any number and combination of electronics fastening methods commonly known to those familiar with the art. The bobbin mounting plate holds the base plate is designed to receive the pickup bobbin mounting plate and mechanically attach it to the guitar while making all necessary electronic contact with the bobbin mounting plate's electrical contacts.

The described structure which connects the bobbin, or bobbins, to the instrument for turning the string vibrations into electric signals, may come in a plurality of shapes, sizes and electrical contacts to accommodate a plurality of pickup styles, electronics and sizes.

The features of the present invention which are believed to be novel are set forth in this application and in particular, in the appended claims. Other objectives and many of the features of this invention will be more readily appreciated and understood by reference to the following detailed descriptions and diagrams.

Other features and advantages of the invention are apparent from the following description, and from the claims.

### DESCRIPTION OF DRAWINGS

FIG. 1 is an illustration of the detachable pickup system mounted in an instrument and shows two embodiments of the invention outside of the instrument.

FIG. 2 is an illustration to show the details of the pickup bobbin mounting plate, the bobbin assembly, the contacts and the body mounting plate of the invention.

FIG. 3 is a section view illustration of the compliant electrical contacts as assembled.

FIG. 4 is a detailed cross section illustration of the snap fit and compression foam to create an opposing force to the main connecting members.

FIG. 5 is an illustration of a second embodiment of the invention with an alternative single pivot and snap attachment method.

FIG. 6 is an illustrious of multiple conductors and wires.

FIG. 7 is an illustration of a key feature.

### DESCRIPTION

Section of the Description

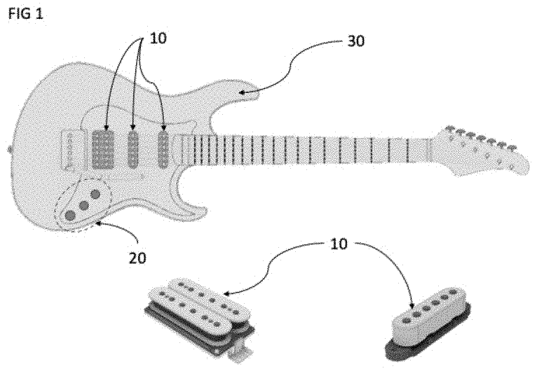

The present invention is a detachable electronic instrument pickup system, made for high SPL playing as well as a plurality of environmental conditions common with today's live performances and for ease of use. FIG. 1 shows that it is comprised of a detachable pickup system 10 with an electronics control system 20 to an instrument like an electric guitar 30.

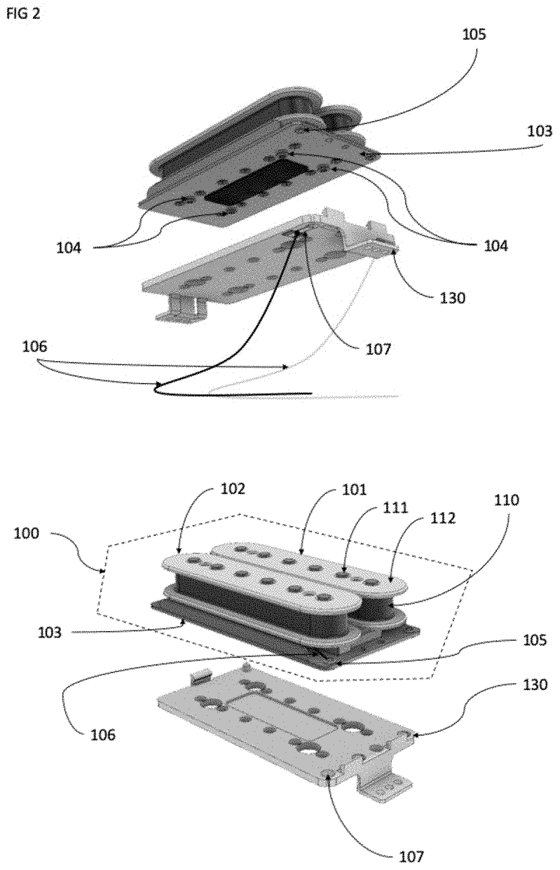

FIG. 2 shows a view of one embodiment of the pickup system removable pickup assembly 100. It is comprised of bobbin assembly 101, a second bobbin assembly 102, a bobbin mounting plate 103, bobbin mounting plate electric contacts 105 which are connected to wires 106 for the flow of electrical signal from the bobbin assembly to the bobbin mounting plate electric contacts 107 with their associated wires 106. The bobbin assembly 101, is comprised of a wire coil 110, magnets 111, and a magnet and coil holder 112. The bobbin assemblies 101 and 102 are mounted to the bobbin mounting plate 103 via a screw 104 or glue or snap fit or any plurality of fastening methods or combination thereof creating a removable pickup assembly 100. The body mounting plate 130 is attached to the instrument 30 via a plurality of methods known to instrument manufacturers, typically using screws to hold the pickup in place, these screws also may provide height adjustment in some embodiments.

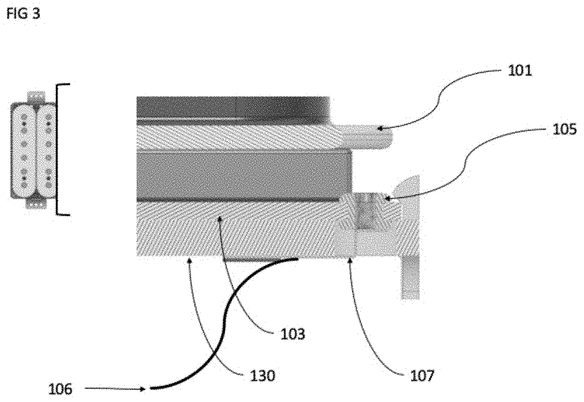

FIG. 3 shows the a cross section of the detachable pickup assembly 100 connecting the wire coil 110 to a wire 106 or directly to the bobbin mounting plate's 103 bobbin mounting plate electrical contact 105, that transfers the pickup signal to the contacts on the body mounting plate 130 via the body mounting plate's electrical contact 107. The mounting plate contacts 107 are then connected to the instrument's 30 electronics 20 through the wires 106 and the electronics 20 may modify the signal in amplitude and/or frequency response. The signal then flows to an amplifier that convert the electric signal to sound waves via a speaker. The bobbin mounting plate contact 105 is affixed to the bobbin mounting plate 103 and connected to the wire coil 110 at one or more places, most often at the start and end of the coil. In some embodiments a third coil output wire may be attached at the center of the coil wind, or at 25% of the wind, and at any point along the coil or a plurality of points on the coil. The system can accommodate a plurality of wire coil output wires and associated electrical contacts. The body mounting plate contact 107 performs a similar function as the bobbin mounting plate contact 105 in that it creates a connection from the contact to the wires however it allows the signal to move to the instrument's 30 electronics. These contacts are design to be compliant in order to allow for tolerance differences in the pickup assembly's 10 components, allow for any instrument's 30 design, endure a plurality of vibrations and operating through any changes in operating temperature without losing contact and thus electrical signal. By using compliant contacts, the system allows for normal variability in the system's design and manufacturing and allows the signal to flow through the contacts unimpeded. Compliant contacts are made of ductile, conductive materials that keep electrical contact over a variety of operating temperatures, vibrations, tolerance stacks and other influences that may disrupt the connection and flow of signal. In this embodiment, these contacts 105 and 107 serve no mechanical fastening or retention purpose and are free to flex and stay connected over a plurality of operating scenarios such as while vibrating, with temperature changes, accommodating tolerance stacks, and other scenarios to retain electrical contact as known to those knowledgeable in the art.

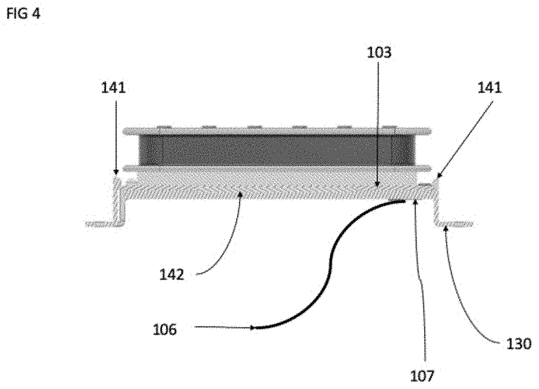

FIG. 4 shows a detailed view of an assembly method that allows for the removable pickup system's 100 bobbin mounting plate 103 to snap into place with the body mounting plates 130 using a flexible snapping feature 141 which allows for simple removal of the assembly 100 while creating with a very strong retaining force. The strong retaining force may come from a designed interference fit uses the snapping features 141 clamping force to hold the bobbin mounting plate 103 firmly to the body mounting plate 130. In some embodiments the snapping feature 141 may be integrated into the bobbin mounting plate 103 instead of the body mounting plate as shown in FIG. 4. In some embodiments, a compressible foam spacer 142 may be used to create an opposing force to the snapping feature 141 to create a retaining force in order to eliminate microphonic feedback caused by vibrations due to high Sound Pressure Levels (SPL). This strong retaining force makes the removable pickup assembly 100 act as one unit at the bobbin mounting plate 103 and the body mounting plate 130, meaning the assembly behaves as though they are a single component in vibration response and characteristics over the operating parameters of music making from low to high Sound Pressure Levels and over the entire frequency range of music. For those knowledgeable in the art, there are many methods for creating the clamping force for the mounting mechanism so that the two members vibrate similarly to a single component over the frequency range of music, such methods may include, but are not limited to, compressible foam, springs, compliant plastic features, compression zones, compression features, interference fits, and any number of concepts known to create an opposing force to the mechanical connections retaining force to causing a clamping force and minimize/mitigate/eliminate differing vibrations over a specified frequency range. Another method for creating a strong retaining force between the bobbin mounting plate 103 and the body mounting plate 130 is a screw, or plurality of screws connecting the two mounting plates. Though this does not allow for pickup changes to happen without a tool, or as quickly as a snap fit, it does allow for pickup changes to happen much faster, and with lower technical skills, than a conventional pickup system. To those knowledgeable in the art, there are many methods for creating the strong and removable connection between the bobbin mounting plate 103 and the body mounting plate 130 that enable the two pieces to behave in a vibrating environment as a single unit over the frequency range of music, including, but not limited to, snap fits, screws, quarter-turn fasteners, cam locks, magnets, expandable shaft and ferrule, pinned shafts, low tack adhesives, and the like, and in any combination of one or more of these methods. It is possible to use any of these features in one or more locations to connect the bobbin mounting plate 103 to the body mounting plate 130.

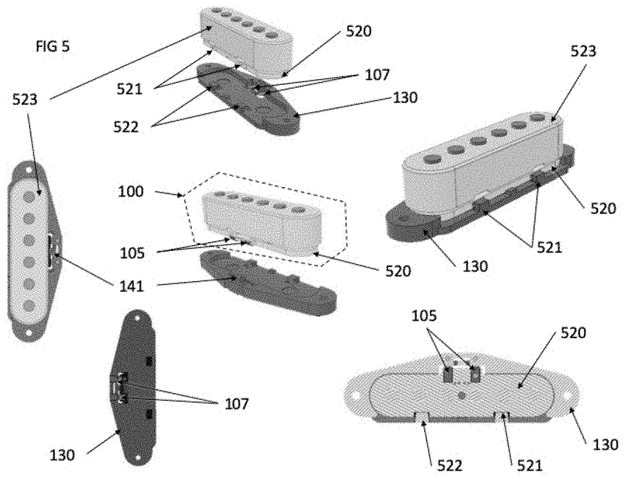

In FIG. 5 shows a single bobbin embodiment of the pickup assembly 10 that uses a body mounting plate 130 with additional features and electric connection features integrated into the bobbin assembly 100, versus being a separate part as show in FIG. 1 item 103 onto which the bobbin assembly 101 is mounted. Due to space limitation in the body of the instrument 30, a design where the magnet and coil holder 112 integrates features for mechanical attachment may provide a more useful solution for some instruments 30 based on their existing or future designs, effectively combining the functions of the magnet and coil holder 112 and the bobbin mounting plate 103 into one part. FIG. 5 shows a locking feature that is not a snap fit, but a retaining pocket 521 and a retaining protrusion 522 that is used to hold one side of the bobbin mount plate 103 to the body mounting plate 130 by using a pivot point concept and rotating the bobbin assembly 100 into a snap fit 141. This methodology accommodates smaller spaces in the instrument because only one snap fit 141 needs room/volume to flex during insertion and removal of the pickup assembly 100. This pivot point may also be shaped to act as a cam and get tighter as the pickup is rotated into place and held by the snap fit feature 141. A plurality of methodologies can be used exclusively or in combination to ensure the bobbin mounting plate 520 and the body mounting plate 130 act as one in vibration such as, but not limited to, snap fits, screws, quarter turn fasteners, cam locks, magnets, etc. used singularly or in combination with other retention concepts. This embodiment also shows an assembly cover 523 that is optional on bobbin assembly 101 or may cover a plurality of robin assemblies at the same time with one cover.

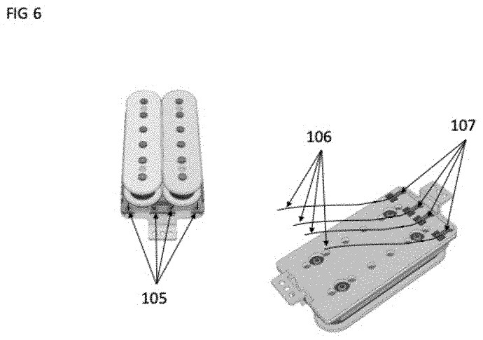

It is possible for the system to have a plurality of wires and contacts to accommodate any number of coils used to convert the string vibrations to electric signals and any number of wiring options for the body of the guitar, FIG. 6 shows a four conductor embodiment of the removable pickup assembly 100 shown in FIG. 1, where four bobbin mount plate contacts 105 and four body mounting plate contacts 107, each with associated wires 106, as examples of a plurality of contacts and wires as described in FIG. 3. It is possible to have any number of contacts as required by the pickup style and/or instrument style. This “split coil” option is very popular in dual coil pickups, often called “humbucking” pickup assemblies. The pickup assembly 10 in this embodiment has 4 contacts 105 and 107 along with 4 wires 106, and the electronics in the instrument 20 are designed to accommodate the “4 conductor” 106 system and to control the flow of electricity in a number of ways using switches, potentiometers, capacitors and the like.

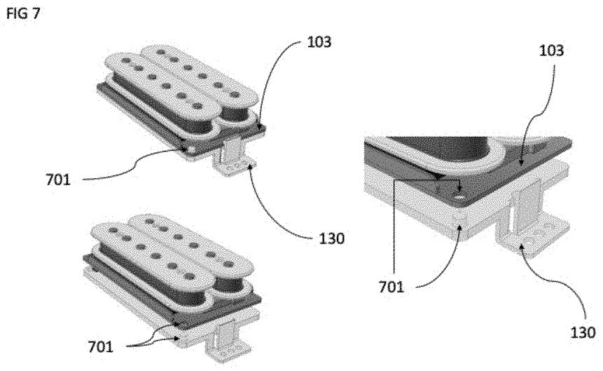

FIG. 7 shows an embodiment of the detachable pickup system 10 with a “keying” feature 701 to ensure proper installation alignment and compatibility of a bobbin mounting plate 103 into a body mounting plate 130. This alignment feature is useful for making sure the contacts are properly aligned, or as a “blocking” or “keying” feature for instruments that have active electronics which use a battery to create a DC voltage or signal in the bobbin assembly. For pickups that are not designed to accommodate this DC voltage, the DC voltage would likely damage the pickup. To prevent the accidental installation of an inappropriate removable pickup system 100, a “blocking” or “keying” feature 701 may be used. For example, a square protrusion may be added to the bobbin mounting plate 103 that will not fit in a round hole on the body mounting plate 130, thus preventing an improper installation. Likewise, a protrusion may be designed on the body mounting plate 130 with a receiving keying feature in the bobbin mounting plate 103. This concept works for an integrated bobbin mounting plate 520 as shown in FIG. 5. Keying features are used in many applications in electronics and safety systems, and come in a plurality of styles, designs and material considerations, and are well known to those knowledgeable in the art.

U.S. Pat. No. 4,854,210 teaches that a double coil mounting plate can accommodate a single coil pickup assembly. Likewise, the invention can accommodate a plurality of coil shapes, counts and assembly styles to those knowledgeable in the art.

It is to be understood that the foregoing description is intended to illustrate and not to limit the scope of the invention, which is defined by the scope of the appended claims. Other embodiments are within the scope of the following claims.

What is claimed is:

1. A docking system for an electromagnetic pickup of a musical instrument, the docking system comprising:
an electromagnetic pickup mounting plate upon which the electromagnetic pickup is mounted, the electromagnetic pickup mounting plate including a first electrical contact configured to be electrically connected to the electromagnetic pickup;
a body mounting plate including:
a second electrical contact configured to electrically connect to the first electrical contact of the electromagnetic pickup mounting plate and to be electrically coupled to external electronics for receiving electrical signals from the electromagnetic pickup; and
a mechanical detent configured to mechanically interface with the electromagnetic pickup mounting plate to detachably secure the electromagnetic pickup mounting plate to the body mounting plate.

2. A detachable electric stringed instrument pickup system for an electrical stringed instrument that comprises:
a removable pickup system is attached to a body of an electrical stringed instrument under a plurality of strings; and
a base plate attached by screws to said instrument; and
a first connector means for electrical connection mounted on said base plate; and
an assembly mount; and
a second connector means for electrical connection mounted on said assembly mount and detachably into said first connector; and
a means for an electromagnetic pickup mounted on said assembly mount and having at least one magnet and at least one conducting coil of wire having a beginning and an end, wound around said magnet with the beginning and end of said conducting coil of wire electrically connected to said second connector means.

3. The detachable electric stringed instrument pickup system of claim 2 further comprising a compliant electric contacts system.

4. The detachable electric stringed instrument system of claim 2 further comprising a bobbin mounting plate and a body mounting plate that when attached to one another with an interference fit ensuring a vibration profile similar to a single member over the music spectrum.

5. A detachable electric stringed instrument pickup system for an electrical stringed instrument that comprises:
a mounting fixture wherein said mounting fixture is attached to a body of an electrical stringed instrument under a plurality of strings; and
a base plate attached by height adjustment screws to said mounting fixture; and
a height adjustment spring biasing said base plate away from said mounting fixture; and
a first connector means for electrical connection mounted on said base plate; and
a second connector means for electrical connection mounted on said base plate; and
an assembly mount; and
a third connector means for electrical connection mounted on said assembly mount; and
a fourth connector means for electrical connection mounted on said assembly mount; and
a means for electromagnetic pickup mounted on said assembly mount and having at least one magnet and at least one conducting coil of wire having a beginning and end wound around said magnet with said beginning of said conducting coil of wire electrically connected to said third connector means and said end of said conducting coil of wire electrically connected to said fourth connector means; and wherein said first connector means is aligned with said third connector means and said second connector means is aligned with said fourth connector means; and wherein said assembly mount is detachably connected to said base plate through said opening in said mounting fixture such that said first connector means connects to said third connector means and said second connector means connects to said fourth connector means.

6. The detachable electric stringed instrument pickup system of claim 5, wherein said first connector and second connector means each comprise a compliant contact and said third connector means and fourth connector comprise a compliant contact.

7. In a detachable electric stringed instrument pickup system for an electrical stringed instrument, having a mounting fixture having an opening wherein said mounting fixture is attached to the body of the electrical stringed instrument under the strings, a base plate attached by height adjustment screws to the mounting fixture, and a height adjustment spring biasing the base plate away from the mounting fixture, wherein the improvement comprises: a first connector means for electrical connection mounted on said base plate, an assembly mount, a second connector means for electrical connection mounted on said assembly mount and detachably connected into said first connector means through an opening in said mounting fixture and a means for electromagnetic pickup mounted on said assembly mount and electrically connected to said second connector means.

8. In a detachable electric stringed instrument pickup system according to claim 7, wherein said means for electromagnetic pickup comprises a conducting coil wound around at least one magnet, said conducting coil having a beginning and an end, wherein said second connector means comprises a first contact electrically connected to said beginning of said conducting coil and a second contact electrically connected to said end of said conducting coil and wherein said first connector means comprises a first compliant contact mounted on said base plate in alignment with said first complaint contact mounted on said assembly mount and a second compliant contact mounted on said base plate in alignment with said second plug mounted on said assembly mount such that said first compliant contact is detachably pluggable into said first compliant contact and said second complaint contact is detachably pluggable into said second contact.

9. In a detachable electric stringed instrument pickup system according to claim 7, wherein said means for electromagnetic pickup comprises a plurality of conducting coils each wound around at least one magnet, each of said plurality of conducting coils having a beginning and an end, wherein said second connector means comprises a matching plurality of first male connectors each electrically connected to said beginning of one of said plurality of conducting coils and a matching plurality of second male connectors each electrically connected to said end of one of said plurality of conducting coils and wherein said first connector means comprises a matching plurality of first female connectors mounted on said base plate in alignment with said matching plurality of first male connectors mounted on said assembly mount and a matching plurality of second female connectors mounted on said base plate in alignment with said matching plurality of second male connectors mounted on said assembly mount such that each said first male connector is detachably pluggable into each said first female connector and each said second male connector is detachably pluggable into each said second female connector.

10. In a detachable electric stringed instrument pickup system according to claim 7, wherein said means for electromagnetic pickup comprises a plurality of conducting coils each wound around at least one magnet, each of said plurality of conducting coils having a beginning and an end, wherein said second connector means comprises a matching plurality of first female connectors each electrically connected to said beginning of one of said plurality of conducting coils and a matching plurality of second female connectors each electrically connected to said end of one of said plurality of conducting coils and wherein said first connector means comprises a matching plurality of first male connectors mounted on said base plate in alignment with said matching plurality of first female connectors mounted on said assembly mount and a matching plurality of second male connectors mounted on said base plate in alignment with said matching plurality of second female connectors mounted on said assembly mount such that each said first female connector is detachably pluggable into each said first male connector and each said second female connector is detachably pluggable into each said second male connector.
